(19) United States
(12) Patent Application Publication
(10) Pub. No.: US 2022/0107633 A1
(43) Pub. Date: Apr. 7, 2022

(54) Transportation Robot Mesh Manufacturing Environment

(71) Applicant: Dell Products L.P., Round Rock, TX (US)

(72) Inventors: Richard Fitzpatrick, Stoughton, MA (US); Christopher J. LeBeau, Lakeville, MA (US); Michael R. Magnan, Cumberland, RI (US)

(73) Assignee: Dell Products L.P., Round Rock, TX (US)

(21) Appl. No.: 17/062,002

(22) Filed: Oct. 2, 2020

(51) Int. Cl. G05D 1/00; G05B 19/4155; B66F 9/06; G05D 1/02

(52) U.S. Cl. CPC G05D 1/0016; G05B 19/4155; G05D 2201/0216; G05D 1/0276; G05B 2219/50362; B66F 9/063

(57) ABSTRACT

A system and method for performing a transportation robot control operation. In various embodiments, the transportation robot control operation includes placing a transportation robot control device in a location of a manufacturing facility, the transportation robot control device comprising a transportation robot summoning portion; actuating the transportation summoning portion; transmitting a summoning command to the transportation robot; and, causing the transportation robot to travel to the location within the manufacturing facility corresponding to the transportation robot control device.

### BACKGROUND OF THE INVENTION

### Field of the Invention

The present invention relates to information handling systems. More specifically, embodiments of the invention relate to an information handling system manufacturing environment.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

In one embodiment, the invention relates to a method for controlling a transportation robot comprising: placing a first transportation robot control device in a first location of a manufacturing facility, the first transportation robot control device comprising a first transportation robot summoning portion; actuating the first transportation summoning portion; transmitting a summoning command to the transportation robot in response to the actuating; and, causing the transportation robot to travel to the first location of the manufacturing facility in response to the summoning command.

In another embodiment the invention relates to a transportation robot control device comprising: a processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: determining when a first transportation summoning portion is actuated; transmitting transportation robot summoning command to a transportation robot; and, causing the transportation robot to travel to a location within a manufacturing facility corresponding to a location of the manufacturing facility.

In another embodiment, the invention relates to a manufacturing environment comprising: a transportation robot; and, a transportation robot control device, the transportation robot control device comprising a processor; and a non-transitory, computer-readable storage medium embodying computer program code, the non-transitory, computer-readable storage medium being coupled to the data bus, the computer program code interacting with a plurality of computer operations and comprising instructions executable by the processor and configured for: determining when a first transportation summoning portion is actuated; transmitting transportation robot summoning command to a transportation robot; and, causing the transportation robot to travel to a location within a manufacturing facility corresponding to a location of the manufacturing facility.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the system and method of the present invention.

FIG. 2 shows a block diagram of a product configuration and fabrication environment.

FIG. 3 shows a functional block diagram of a custom product fabrication environment.

FIG. 4 shows a block diagram of an example manufacturing facility.

FIG. 5 shows a perspective view of an example robotic function control device.

FIG. 6 shows a schematic view of an example robotic function control device.

FIG. 7 shows a flow chart of the transportation robot control operation.

FIG. 8 shows an example transportation robot user interface screen presentation.

### DETAILED DESCRIPTION

Various aspects of the present disclosure include an appreciation that transporting items within a manufacturing facility (especially large custom product fabrication facilities) can be time consuming for technicians performing various tasks within the manufacturing facility. When transporting an item, the technician would often place the item on a cart and physically move the item from one location in the manufacturing facility to another location within the manufacturing facility. Various aspects of the present disclosure include an appreciation that in custom product fabrication facilities the locations may be several hundred feet apart or more, thus resulting in transporting items consuming an undesirable amount of the technician's time.

Various aspects of the present disclosure include an appreciation that transportation robots such as autonomous intelligent vehicles (AIV) or autonomous mobile robots (AMR) require some form of network connection to be able to summon the robot to a particular location when needed. If transportation robot is not reconfigured from any default network settings or doesn't have enough security settings, the robot can pose a security risk for an established IT network, or vice versa. If the IT network is compromised, the robot could be affected from the intrusion, causing a loss of control and potentially damaging assets.

Various aspects of the present disclosure include an appreciation that an information technology (IT) infrastructure within a manufacturing facility may be bandwidth limited due, for example, to the amount of information that is involved in fabricating devices within the manufacturing facility. Various aspect of the present disclosure include an appreciation that limited bandwidth can affect the efficiency of various operations, such as transportation operations, within the manufacturing facility.

A system and method are disclosed for performing a transport robot control operation. In various embodiments, the transport robot control operation uses a mobile router that supports a WiFi protocol such as the 802.11s network protocol in combination with a IoT compute device (e.g., a Raspberry Pi type device) so that a one hundred percent air-gapped network infrastructure can be established for communicating with a transport robot. In various embodiments, any commercially available transport robot can be retrofitted with the configured mobile router. In various embodiments, IoT compute device can be configured and coded to function with various transport robots that run on a Robot Operating System (ROS) with ROSBridge access enabled. In various embodiments, the transport robot control operation messaging between a call box and transportation robot uses machine-to-machine connectivity protocols (MQTT).

In various embodiments, the transport robot control operation provides an air gapped mesh network to keep the transportation robot and associated IoT devices off of corporate networks. In various embodiments, the transport robot control operation can be customized to allow for call boxes to be used with a plurality of transportation robots, each of which may be executing a ROS. Dedicated hardware solution that doesn't require a tablet/computer/smartphone running fleet software. Additional call boxes can be added to expand coverage area.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

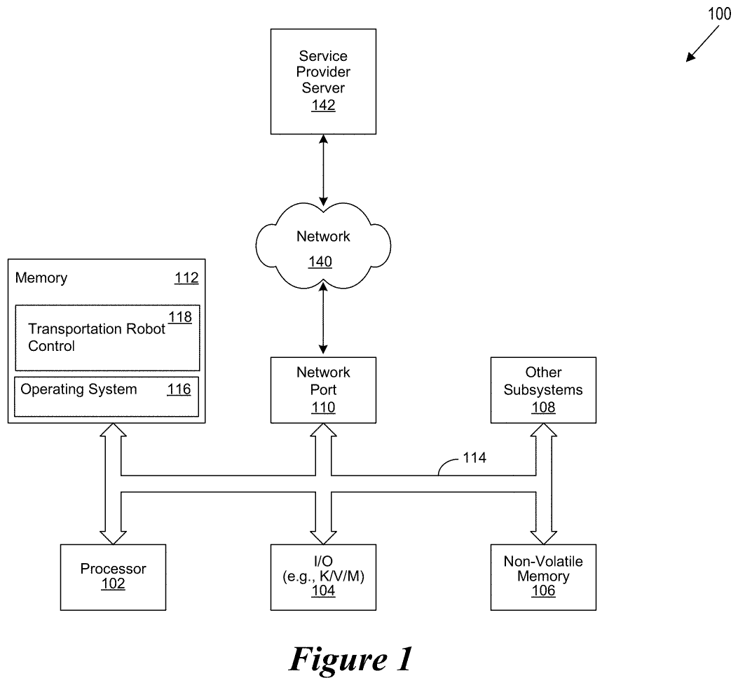

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116 and in various embodiments may also comprise a transportation robot control system 118.

The transportation robot control system 118 performs a transportation robot control operation. The transportation robot control operation improves processor efficiency (and thus the efficiency of the information handling system 100) by facilitating control of a transportation robot. As will be appreciated, once the information handling system 100 is configured to perform the transportation robot control operation, the information handling system 100 becomes a specialized computing device specifically configured to perform the transportation robot control operation and is not a general purpose computing device. Moreover, the implementation of the transportation robot control operation on the information handling system 100 improves the functionality of the information handling system and provides a useful and concrete result of controlling a transportation robot.

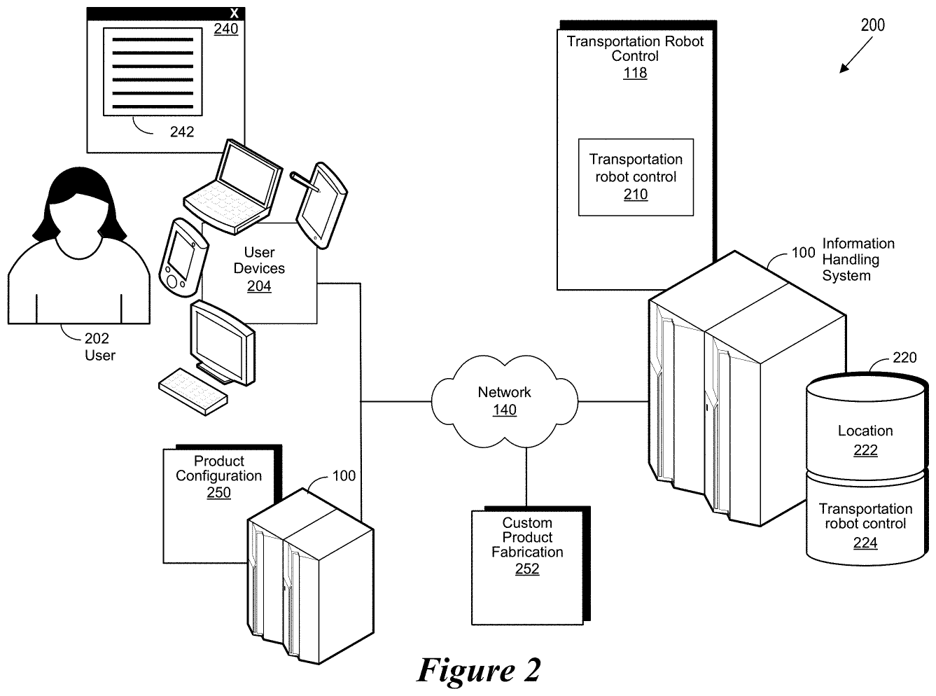

FIG. 2 is a block diagram of a product configuration and fabrication environment 200 implemented in accordance with an embodiment of the invention. The product configuration and fabrication environment 200 includes a transportation robot control system 118.

In various embodiments, a user 202 generates a user action which is received by a transportation robot control system 118. In various embodiments, a transportation robot control system 118 executes on a hardware processor of an information handling system 100. In these and other embodiments, the user 202 may use a user device 204 to interact with the transportation robot control system 118. In various embodiments, the transportation robot control system 118 may be included within a transportation robot, a robotic function control device or a combination of a transportation robot and a robotic function control device.

In various embodiments, the transportation robot control system 118 and the transportation robot execute a transportation robot control operation. In various embodiments, the transportation robot control operation uses a mobile router that supports a WiFi protocol such as the 802.11s network protocol in combination with a IoT compute device (e.g., a Raspberry Pi type device) so that a one hundred percent air-gapped network infrastructure can be established for communicating with a transport robot. In various embodiments, any commercially available transport robot can be retrofitted with the configured mobile router. In various embodiments, IoT compute device can be configured and coded to function with various transport robots that run on a Robot Operating System (ROS) with ROSBridge access enabled. In various embodiments, ROSBridge provides an application program interface (API) which allows robotic operating system functionality to non-ROS programs. In various embodiments, the transport robot control operation messaging between a call box and transportation robot uses machine-to-machine connectivity protocols such as a Message Queueing Telemetry Transport (MQTT) type network protocol. In various embodiments, the machine-to-machine connectivity protocol provides ordered, lossless, bi-directional connections between the transportation robot control system 118 and a transportation robot.

As used herein, a user device 204 refers to an information handling system such as a personal computer, a laptop computer, a tablet computer, a personal digital assistant (PDA), a smart phone, a mobile telephone, or other device that is capable of communicating and processing data. In various embodiments, the user device 204 may be included within a transportation robot, a robotic function control device or a combination of a transportation robot and a robotic function control device. In various embodiments, the user device is configured to present a transportation control interface 240. In various embodiments, the transportation control interface 240 enables control of the transportation robot, the robotic function control device or a combination of the transportation robot and the robotic function control device. In various embodiments, the user device 204 is used to exchange information between the user 202 and the transportation robot control system 118 through the use of a network 140. In certain embodiments, the network 140 may be a public network, such as the Internet, a physical private network, a wireless network, a virtual private network (VPN), or any combination thereof. In certain embodiments, the network 140 may be a peer to peer network. Skilled practitioners of the art will recognize that many such embodiments are possible and the foregoing is not intended to limit the spirit, scope or intent of the invention.

In various embodiments, the transportation robot control system 118 includes a transportation robot control module 210 which performs a transportation robot control operation. In various embodiments, the product configuration and fabrication environment 200 includes a storage repository 220. The storage repository may be local to the system executing the transportation control system 118 or may be executed remotely. In various embodiments, the storage repository includes one or more of a location repository 222 and a transportation robot control repository 224. In various embodiments, a version of some or all of the location repository may be stored within a transportation robot.

In various embodiments, a user device 204 interacts with a product configuration system 250 which may be executing on a separate information handling system 100 perform a product configuration operation. In various embodiments, the product configuration operation configures an information handling system for purchase. In various embodiments, the information for purchase includes a plurality of components identified during the product configuration operation. In various embodiments, the product configuration system 250 interacts with a custom product fabrication system 252 which fabricates the configured information handling system. In various embodiments, the custom product fabrication system 252 fabricates products to include components identified during the product configuration operation. In various embodiments, the product configuration operation may be controlled via a website. In various embodiments, the customer product fabrication system 252 may include one or more transportation robots and one or more transportation robot control systems.

For the purposes of this disclosure a website may be defined as a collection of related web pages which are identified with a common domain name and is published on at least one web server. A website may be accessible via a public internet protocol (IP) network or a private local network. A web page is a document which is accessible via a browser which displays the web page via a display device of an information handling system. In various embodiments, the web page also includes the file which causes the document to be presented via the browser. In various embodiments, the web page may comprise a static web page which is delivered exactly as stored and a dynamic web page which is generated by a web application that is driven by software that enhances the web page via user input to a web server.

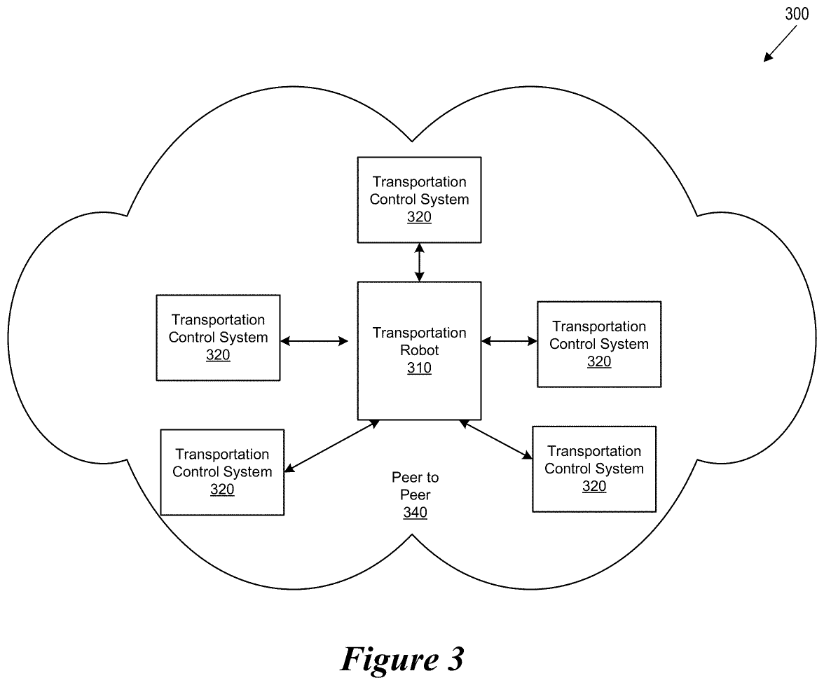

Referring to FIG. 3, a functional block diagram of a custom product fabrication environment 300 is shown. In certain embodiments, the custom product fabrication environment 300 includes a transportation robot 310 as well as a plurality of transportation robot control devices 320. In certain embodiments, the transportation robot 310 includes the transportation robot control system 118. In various embodiments, the customer product fabrication environment 300 includes an information technology network for communicating with various manufacturing components of the custom product fabrication environment 300. In various embodiments, the communicating with the manufacturing components may include providing software loading control instructions to certain manufacturing components, providing debug scripts to certain manufacturing components, providing manufacturing instructions to certain manufacturing components, etc.

At any given time, the transportation robot 310 is controlled via one of the plurality of transportation robot control devices 320. In certain embodiments the transportation robot control devices 320 are located throughout the manufacturing facility environment 300. In certain embodiments, the transportation robot control devices 320 and the transportation robot 310 include a wireless communication capability.

In certain embodiments, the transportation robot control devices 320 communicate with each other and with the transportation robot 310 over a peer to peer network 340. In certain embodiments, the peer to peer network is dedicated to communication between the transportation robot control devices 320 and the transportation robot 310. In certain embodiments, the peer to peer network 340 is in addition to the information technology network of the manufacturing facility environment 300. As used herein, a peer to peer network may be defined as a distributed application architecture that partitions tasks or workloads between peers where the peers are equally privileged participants. Each peer is considered to be a node of the peer to peer network. Each peer (e.g., each transportation robot control device 320 and the transportation robot 310) makes a portion of their resources directly available to other network participants without a need for central coordination. Peers are both suppliers and consumers of resources. The transportation robot control devices 320 and the transportation robot 310 may be considered diverse peers that bring unique resources to the peer to peer network. In certain embodiments, the transportation robot control devices 320 communicate with each other and with the transportation robot 310 via a wireless mesh network. With a wireless mesh network, each node of the peer to peer network also functions as a router. The router function allows direct addressing of node that are not directly connected because intermediate nodes pass a message along until it reaches the target node. In certain embodiments, the message is only passed to a next node (or nodes) which are topologically closer to an intended target so that the message is not broadcast to the entire peer to peer network. It will be appreciated that additional transportation robot control devices 320 may be included within the manufacturing environment 300.

In certain embodiments, the transportation robot 310 comprises an autonomous intelligent vehicle (AIV). In certain embodiments, the AIV is designed to carry a load of hundreds of pounds (e.g., 600 lbs.) on a plurality of shelves. In certain embodiments, each of the plurality of shelves is configured to carry a respective information handling system or information handling system component. In certain embodiments, the shelves are large enough to carry storage processor (SP) type information handling systems or server type information handling systems. In certain embodiments, the transportation robot comprises an industrial strength, omnidirectional, autonomous mobile robot such as the autonomous mobile robot available under the trade designation Vector from Waypoint Robotics. In certain embodiments, the autonomous mobile robot includes components specifically designed to function within the custom product fabrication environment 300.

In operation, when a technician needs to send a component (such as a Storage Processor) to the location within the manufacturing facility (e.g., a debug area of the manufacturing facility). The technician simply presses the call box button (e.g., an actuator located on a transportation robot control device 320) to summon the transportation robot 310. When the robot 310 arrives at the technician's location, the technician places the component on a shelf of the transportation robot 310.

The technician then indicates the location to which the component should be delivered. In certain embodiments, the technician provides this indication by interacting with an interface presented on the transportation robot 320.

The transportation robot 320 then chooses an efficient path to move to its destination, using a map of the manufacturing facility that is stored in location repository within the transportation robot. The transportation robot 310 then safely navigates the aisles of the manufacturing facility using safety rated two dimensional (2-D) and three dimensional (3-D) sensors. In certain embodiments the sensors include light detection and ranging (LiDAR) scanners to detect obstacles and maneuver around people. When the transportation robot 310 arrives at its destination transportation robot 310 announce its arrival. In various embodiments, the announcement is through one or both of audible and visual alerts.

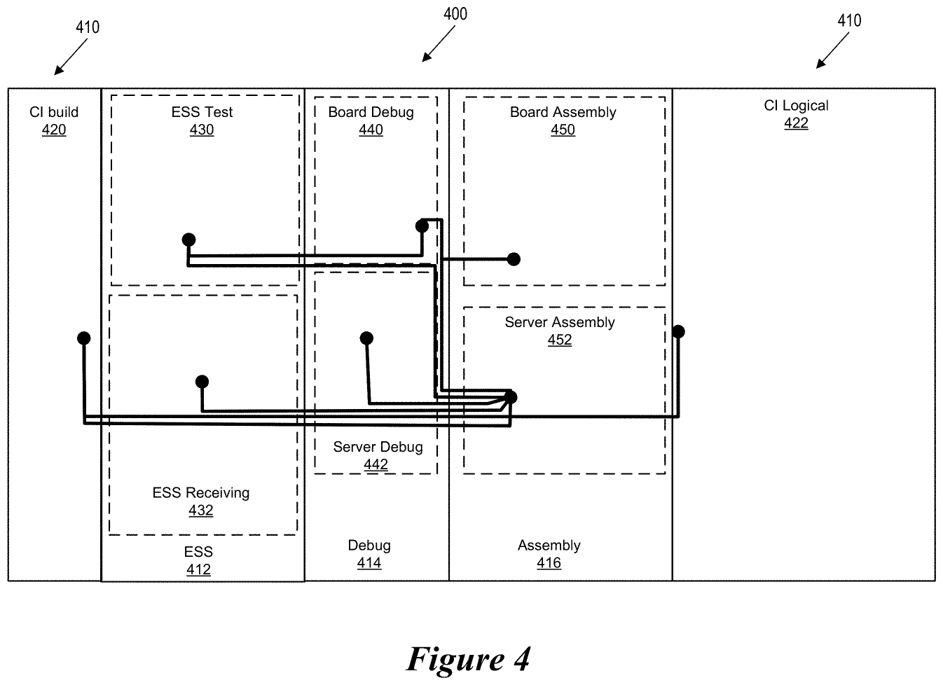

Referring to FIG. 4, a block diagram of an example manufacturing facility 400 is shown. More specifically, in certain embodiments, the manufacturing facility 400 comprises a custom product configuration manufacturing facility. In certain embodiments, the manufacturing facility 400 corresponds to custom product fabrication system 250.

In certain embodiments, the manufacturing facility includes a converged infrastructure (CI) portion 410, an environmental stress screening (ESS) portion 412, a debug portion 414, and an assembly portion 416. The CI portion 410 is located in a rework location of the manufacturing facility 400. The ESS portion 412 is located in an ESS location of the manufacturing facility 400. The debug portion 414 is located in a debug location of the manufacturing facility 400. The assembly portion 416 is located in an assembly location of the manufacturing facility 400. In various embodiments, the CI portion 410 includes a CI build portion 420 and a CI logical portion 422, each of which are located in a respective location in the manufacturing facility 400. In various embodiments, the ESS portion 412 includes an ESS test portion 430 and an ESS receiving portion 432, each of which are located in a respective location in the manufacturing facility 400. In various embodiments, the debug portion 414 includes a board debug portion 440 and a server debug portion 442, each of which are located in a respective location in the manufacturing facility 400. In various embodiments, the assembly portion 416 includes a board assembly portion 450 and a server assembly portion 452, each of which are located in a respective location in the manufacturing facility 400.

In certain embodiments, the transportation robot control devices 320 are located in the CI portion 410 of the manufacturing facility 400, the ESS portion 412 of the manufacturing facility 400, the debug portion 414 of the manufacturing facility 400, and the assembly portion 416 of the manufacturing facility 400. In certain embodiments, the CI portion 410 includes a plurality of transportation robot control devices 320 (e.g., two robotic function control devices) located in different parts of the CI portion 410 (e.g., a first CI location and a second CI location). In certain embodiments, the first location corresponds to the CI build portion 420 and the second location corresponds to the CI logical portion 422. In certain embodiments, the ESS portion 412 includes a plurality of transportation robot control devices 320 (e.g., two robotic function control devices) located in different parts of the ESS portion 414 (e.g. a first ESS location and a second ESS location). In certain embodiments, the first location corresponds to the ESS test portion 430 and the second location corresponds to the ESS receiving portion 432. In certain embodiments, the debug portion 414 includes a plurality of transportation robot control devices 320 (e.g., two robotic function control devices) located in different parts of the debug portion 414 (e.g., a first debug portion and a second debug location). In certain embodiments, the first location corresponds to the board debug portion 440 and the second location corresponds to the server debug portion 442. In various embodiments, the assembly portion 416 includes a plurality of transportation robot control devices 320 (e.g., two robotic function control devices) located in different parts of the assembly portion 416 (e.g., a first board assembly portion and a second board assembly portion. In various embodiments, the first location corresponds to the board assembly portion 450 and second location corresponds to the server assembly portion 452.

In certain embodiments, a transportation robot transports items within the manufacturing facility 400. In various embodiments, a transportation robot transports items within the manufacturing facility under control of the transportation robot control system 118. In various embodiments, a transportation robot transports items between one of the CI portion 410 of the manufacturing facility 400, the ESS portion 412 of the manufacturing facility 400, the debug portion 414 of the manufacturing facility 400, and the assembly portion 416 of the manufacturing facility 400 and another of the CI portion 410 of the manufacturing facility 400, the ESS portion 412 of the manufacturing facility 400, the debug portion 414 of the manufacturing facility 400, and the assembly portion 416 of the manufacturing facility 400. In various embodiments, the CI location may be one of two CI locations. In various embodiments, the ESS location may be one of two ESS locations. In various embodiments, the debug location may be one of two debug locations. In various embodiments, the assembly location may be one of two assembly locations.

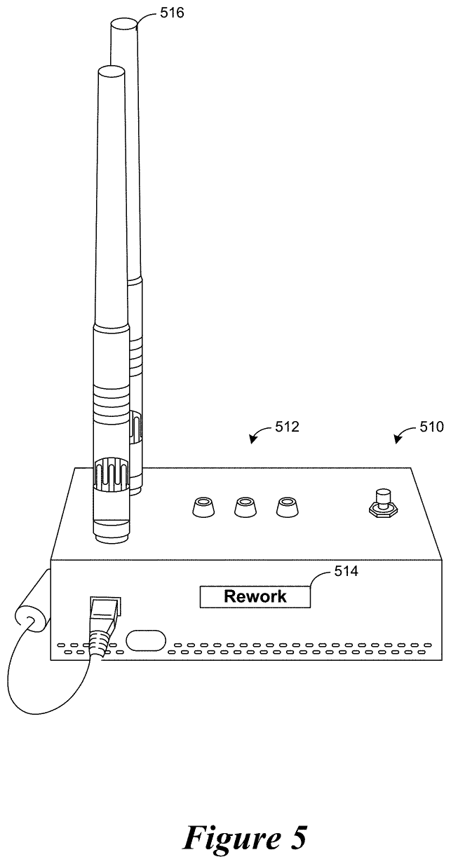

Referring to FIG. 5, a perspective view of an example robotic function control device 500 is shown. In various embodiments the robotic function control device 500 corresponds to a transportation robot control device 320. In various embodiments, the robotic function control device 500 includes a summoning portion 510. In certain embodiments, the summoning portion 510 comprises an actuator. In various embodiments, the summoning portion 510 causes the robotic function control device to generate a summoning command when actuated. In certain embodiments, the actuator comprises a switch. In various embodiments, the robotic function control device 500 includes a status indication portion 512. In various embodiments, the robotic function control device 500 includes a location descriptor portion 514. In various embodiments, the robotic function control device 500 includes one or more antennas 516. In various embodiments, the antennas comprise WiFi antennas such as an antenna conforming to an 802.11 protocol WiFi antenna.

In various embodiments, the robotic function control device 500 provides a standalone, mesh-networked (802.11s protocol) call box that is used to summon a transportation robot to a particular location within a manufacturing facility. In various embodiments, the particular location is indicated via the location descriptor portion 514. In various embodiments, the particular location is programmed into the transportation robot. Additional call boxes are deployed as more locations or a greater coverage area is needed. In general, the robotic function control device comprises a programmable device built from a Raspberry Pi paired with a Wi-Fi router that has 802.11S RF mesh-networking capabilities, as well as programming for communication with other robotic function control devices as well a one or more transportation robots. Each call box expands the coverage area for communication with a transportation robot and allows the status of the robot to be communicated across all robotic function control devices in the mesh.

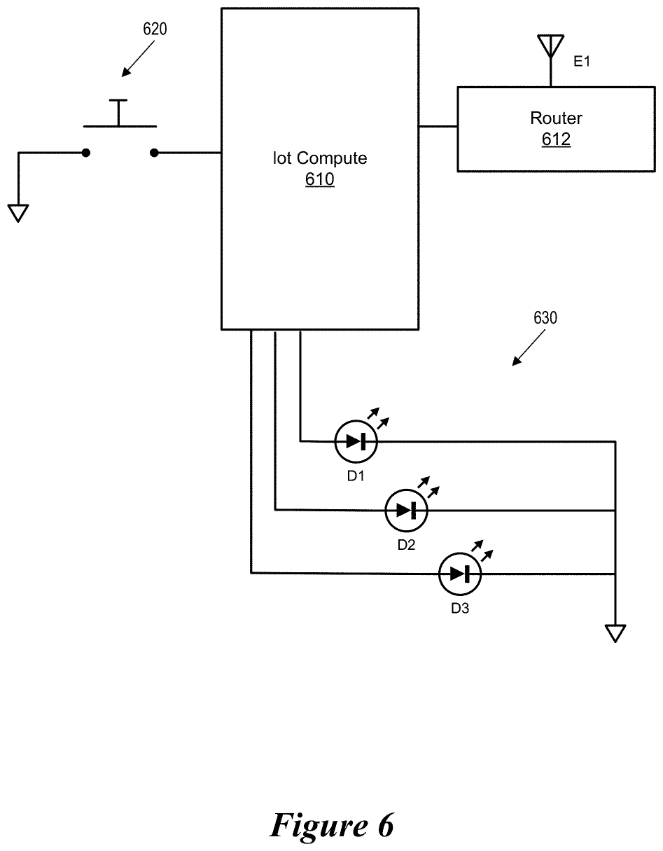

Referring to FIG. 6, a schematic view of an example robotic function control device 600 is shown. In various embodiments, the robotic function control device includes a programmable device 610 coupled to a router 612, a switch component 620 and a transportation robot status portion 630. In various embodiments, the router 612 includes WiFi functionality. In various embodiments, the router 612 configures the robotic function control device 600 as a WiFi station. In various embodiments, the WiFi functionality conforms to an 802.11 protocol such as the 802.11s protocol.

In certain embodiments, the transportation robot status portion comprises a plurality of LED portions. In various embodiments, the programmable device includes an IoT compute device. In various embodiments, the IoT compute device comprises a small footprint information handling system. In various embodiments, the programmable device 610 comprises a Raspberry Pi type programmable device.

In various embodiments, the plurality of LED comprises a green LED portion, a yellow LED portion and a red LED portion. In various embodiments, the transportation robot status portion provides an indication of one or more of whether communication with the transportation robot 310 is functioning properly, whether the transportation robot is available or busy (e.g., is on another mission), and whether a request to summon the transportation robot has been acknowledged by the transportation robot.

In various embodiments, the programmable device 610 includes on-board WiFi functionality. In various embodiments, the on-board WiFi functionality configures the robotic function control device 600 as a WiFi station. In various embodiments, the on-board WiFi functionality conforms to an 802.11 protocol.

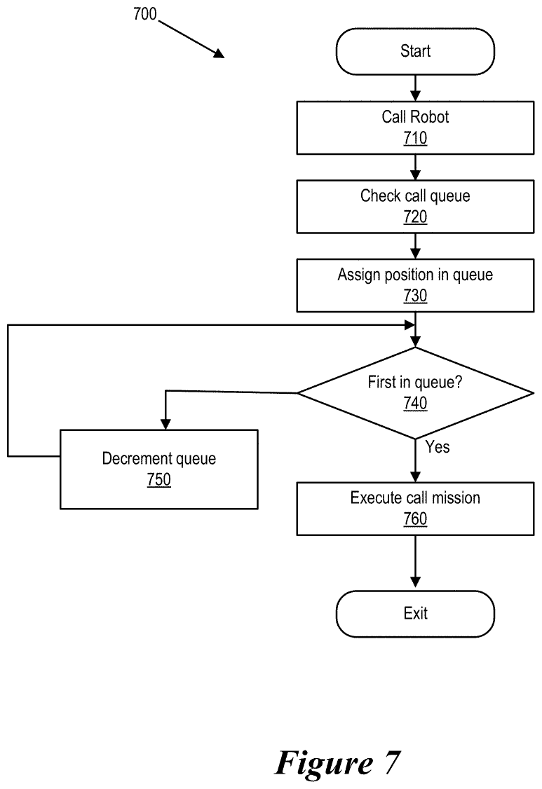

Referring to FIG. 7 a flow chart of the transportation robot control operation 700 is shown. More specifically, the transportation robot control operation starts at step 710 with a call robot function. In various embodiments, the call robot function is initiated by a user actuating the actuator on a call box corresponding to the location to which the user wishes the transportation robot to move. Next at step 720, the transportation robot control operation 700 checks a call queue. In various embodiments, the call queue is checked by the actuated call box communicating with the transportation robot to access a mission queue maintained within the transportation robot. Next at step 730, the transportation robot control operation 700 assigns a value to the call based upon the number of calls in the mission queue. Next at step 740, the transportation robot control operation 700 determines whether the call is the first call in the queue. In various embodiments, this determination is made by the transportation robot based upon the call from the call box. If not, then at step 750, the transportation robot control operation 700 decrements the queue and awaits completion of an earlier mission call in the queue. In various embodiments, the transportation robot decrements the queue when an earlier call when the mission corresponding to the earlier call is completed. If the call is the first call in the queue, then the transportation robot control operation 700 executes the call mission at step 760 and the transportation robot control operation 700 completes. In various embodiments, execution of the call mission causes the robot to relocate to the location corresponding to the call box from which the call mission is initiated.

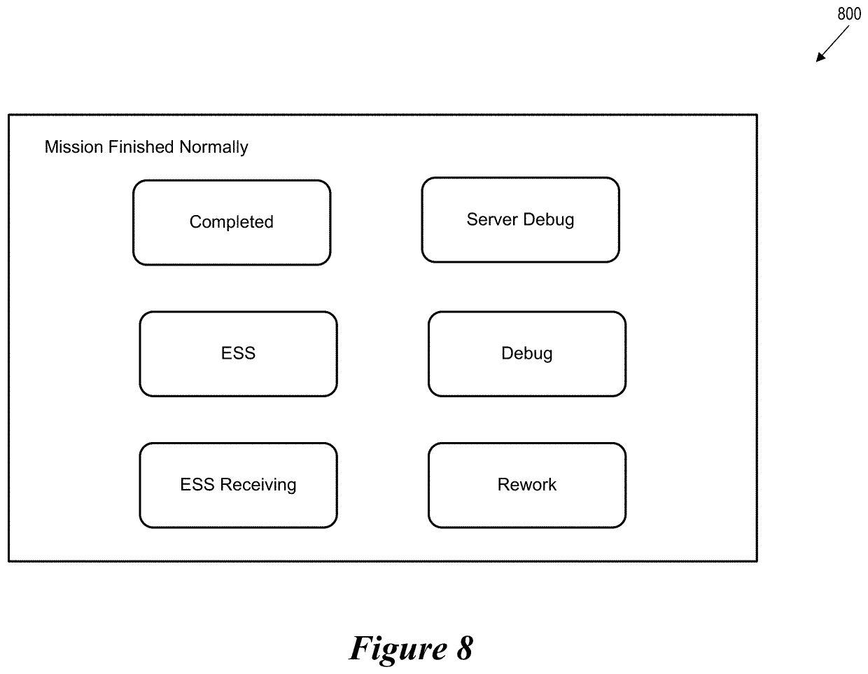

Referring to FIG. 8, an example transportation robot user interface screen presentation 800 is shown. In certain embodiments, the example transportation robot user interface is presented on a touch sensitive type display device. In certain embodiments, the transportation robot user interface 800 enables control of a transportation robot with which the user interface is associated.

In certain embodiments, the transportation robot user interface 800 presents a plurality of actuatable control portions. In certain embodiments, the plurality of actuatable control portions comprise a plurality of location selection portions 810 and a transport completed portion 820. In various embodiments, the plurality of location selection portions 810 includes a server debug location selection, an ESS location selection, a debug location selection, an ESS receiving location selection and a rework location selection.

Other embodiments are within the following claims. For example, the transportation robot could be configured to include additional shelves, to provide automated loading/unloading of material, and to include elevator controls so material can be robotically transported between different levels of a manufacturing facility. Also, for example, some or all the transportation robot devices may include a text display rather than LEDs. In various embodiments, the text display includes functionality to present transportation robot status information, number of calls in a transportation robot queue and a distance from a transportation robot to a caller. Also for example other actuatable control portions may be presented on one or more screen presentations of the transportation robot user interface. Also for example an actuatable control portion may be added when an additional transportation robot control device is added to a manufacturing facility.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object oriented programming language such as Python, Java, Smalltalk, C++ or the like. However, the computer program code for carrying out operations of the present invention may also be written in conventional procedural programming languages, such as the “C” programming language or ‘It’ and similar programming languages. The operations of the present invention can also be implemented using software packages such as SAS, IBM Watson or software packages which support Machine Learning algorithms. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A method for controlling a transportation robot comprising:
placing a first transportation robot control device in a first location of a manufacturing facility, the first transportation robot control device comprising a first transportation robot summoning portion;
actuating the first transportation summoning portion;
transmitting a summoning command to the transportation robot in response to the actuating; and,
causing the transportation robot to travel to the first location of the manufacturing facility in response to the summoning command.

2. The method of claim 1, further comprising:
placing a second transportation robot control device in a second location of a manufacturing facility, the second transportation robot control device comprising a second transportation robot summoning portion;
causing the transportation robot to travel to the second location of the manufacturing facility.

3. The method of claim 2, wherein:
the first transportation robot control device, the second transportation robot control device and the transportation robot communicate via a peer to peer network.

4. The method of claim 1, further comprising:
presenting a plurality of destination location options;
selecting one of the plurality of destination location options; and,
causing the transportation robot to travel to the selected destination location.

5. The method of claim 4, wherein:
the plurality of destination location options are presented via a transportation robot interface.

6. The method of claim 1, wherein:
the transportation robot comprises an autonomous intelligent vehicle.

7. A transportation robot control device comprising:
a processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
determining when a first transportation summoning portion is actuated;
transmitting transportation robot summoning command to a transportation robot; and,
causing the transportation robot to travel to a location within a manufacturing facility corresponding to a location of the manufacturing facility.

8. The transportation robot control device of claim 7, further comprising:
a transportation robot status portion; and the instructions executable by the processor are further configured for:
providing a transportation robot status indication via the transportation robot status portion.

9. The transportation robot control device of claim 8, wherein:
the transportation robot status portion provides an indication of one or more of whether communication with the transportation robot is functioning properly, whether the transportation robot is available or busy and whether a request to summon the transportation robot has been acknowledged by the transportation robot.

10. The transportation robot control device of claim 7, wherein the instructions executable by the processor are further configured for:
providing the transportation robot control device with WiFi functionality; and,
using the WiFi functionality to communicate with the transportation robot.

11. The transportation robot control device of claim 7, wherein:
the processor comprises a Raspberry Pi type programming device.

12. The transportation robot control device of claim 7, wherein:
the transportation robot control device communicates with the transportation robot via a peer to peer network.

13. A manufacturing environment comprising:
a transportation robot; and,
a transportation robot control device, the transportation robot control device comprising
a processor; and
a non-transitory, computer-readable storage medium embodying computer program code, the non-transitory, computer-readable storage medium being coupled to the data bus, the computer program code interacting with a plurality of computer operations and comprising instructions executable by the processor and configured for:
determining when a first transportation summoning portion is actuated;
transmitting transportation robot summoning command to a transportation robot; and,
causing the transportation robot to travel to a location within a manufacturing facility corresponding to a location of the manufacturing facility.

14. The manufacturing environment of claim 13, wherein the transportation robot control device further comprises:
a transportation robot status portion; and the instructions executable by the processor are further configured for:
providing a transportation robot status indication via the transportation robot status portion.

15. The manufacturing environment of claim 14, wherein:
the transportation robot status portion provides an indication of one or more of whether communication with the transportation robot is functioning properly, whether the transportation robot is available or busy and whether a request to summon the transportation robot has been acknowledged by the transportation robot.

16. The manufacturing environment of claim 13, wherein the computer executable instructions are further configured for:
providing the transportation robot control device with WiFi functionality; and,
using the WiFi functionality to communicate with the transportation robot.

17. The manufacturing environment of claim 13, wherein:
the processor comprises a Raspberry Pi type programming device.

18. The manufacturing environment of claim 17, wherein:
the transportation robot control device communicates with the transportation robot via a peer to peer network.
